(19) United States
(12) Patent Application Publication
(10) Pub. No.: US 2008/0184864 A1
(43) Pub. Date: Aug. 7, 2008

(54) Electric guitar including a connection for a digital music player

(76) Inventors: Dennis Holt, West Hollywood, CA (US); Lavere Lund, Sun Valley, CA (US)

Correspondence Address: SEYFARTH SHAW LLP, 131 S. DEARBORN ST., SUITE 2400, CHICAGO, IL, 60603-5803, US

(21) Appl. No.: 11/542,485

(22) Filed: Oct. 3, 2006

(51) Int. Cl. G10H 3/18

(52) U.S. Cl. 84/267; 84/726

(57) ABSTRACT

A stringed instrument including a housing defining an interior space, at least one string on the housing, an amplifier positioned in the interior space and attached to the housing and a pick-up on the housing and positioned adjacent to the string where the pick-up converts vibrations from the string into electrical signals and transmits the electrical signals to the amplifier. The stringed instrument includes an audio input on the housing and coupled to the amplifier, where the audio input is coupled to a digital music player and sound stored by the digital music player is coupled to the amplifier. At least one speaker is mounted in the housing and coupled to the amplifier. The amplifier converts electrical signals from the pick-up into live music and the speaker emits both the live music and the sound from the digital music player to enable a player to play along with the sound.

### BACKGROUND

Musical instruments can be connected to systems which play the sound of other musical instruments, play background music or play accompanying music. Such systems are used by players of musical instruments to produce music which simulates the music of a band or orchestra. These systems are particularly popular with solo musicians. Solo musicians may play along with a song, such as the song of a favorite band, to practice the parts of the song involving their instrument. For example, a guitar player may play along with a song played on a radio, cassette player or compact disk player to try to learn and re-produce the guitar portions of the song.

To play along with a song or background music, electric guitar players typically have to hook up their guitars to an amplifier or a speaker while the music they are playing along with is played from a separate speaker. Having separate speakers and associated equipment requires more space. Furthermore, such a system is also not easily moved from location to location. Each speaker also has its own volume and sound controls. Therefore, guitar players must separately adjust the volume and sound playing from each speaker until a suitable volume and sound level is achieved for each speaker. Adjusting the volume and sound in this way is time consuming.

Some instruments include built-in music players and speakers. For example, some electric keyboards include recordings of different sounds which can be played by the touch of a button and accompany the music played on the keyboards. The following paragraphs describe some to these systems.

U.S. Pat. No. 5,744,744 discloses an electric stringed instrument having an automated accompaniment system which plays sounds from the stringed instrument and the accompaniment system from built-in speakers to simulate the music of a band.

U.S. Pat. No. 6,605,765 discloses an acoustic guitar including a cassette player carried by the body of the guitar. The guitar enables recorded music played by the cassette player and live music played on the guitar by a musician to be simultaneously emitted from a pair of speakers in the body of the guitar.

Musical instruments having built-in speakers and music players reduce the amount of equipment needed to reproduce the music of a band and enable musicians, and more specifically solo musicians, to play such music in any location.

Accordingly, it is desirable to provide portable music systems that include musical instruments that enable players to play live music along with recorded music directly from their instrument.

### SUMMARY

One embodiment of an electric guitar of the present invention provides a stringed instrument including a housing defining an interior space, at least one string on the housing, an amplifier positioned in the interior space and attached to the housing and a pick-up on the housing and positioned adjacent to the string where the pick-up converts vibrations from the string into electrical signals and transmits the electrical signals to the amplifier. The stringed instrument includes an audio input on the housing and coupled to the amplifier, where the audio input is coupled to a digital music player and sound stored by the digital music player is coupled to the amplifier. At least one speaker is mounted in the housing and coupled to the amplifier. The amplifier converts electrical signals from the pick-up into live music and the speaker emits both the live music and the sound from the digital music player to enable a player to play along with the sound.

A feature of the present invention is to provide a stringed instrument that enables a player to play live music using the instrument along with sound stored in a digital music player.

Another feature of the present invention is to provide an electrical guitar that enables a player to play live music along with any one of numerous sounds stored in a digital music player.

Other objects, features and advantages of the invention will be apparent from the following detailed disclosure, taken in conjunction with the accompanying sheets of drawings, wherein like numerals refer to like parts, elements, components, steps and processes.

### DESCRIPTION OF THE FIGURES

FIG. 1 is a perspective view of one embodiment of an electric guitar of the present invention.

FIG. 2 is a bottom view of the electric guitar of FIG. 1.

FIG. 3 is a right side view of the electric guitar of FIG. 1.

FIG. 4 is a cross-section view of the electric guitar of FIG. 1 taken substantially along the line 4-4.

FIG. 5 is a schematic block diagram of the electric guitar of FIG. 1.

### DETAILED DESCRIPTION

The present invention is directed generally to a electric stringed instrument, and more specifically, to an electric guitar including an audio input, a built-in amplifier and a built-in speaker that enables a guitar player to play live music from the electric guitar along with thousands of different songs stored in a digital music player connected to the guitar.

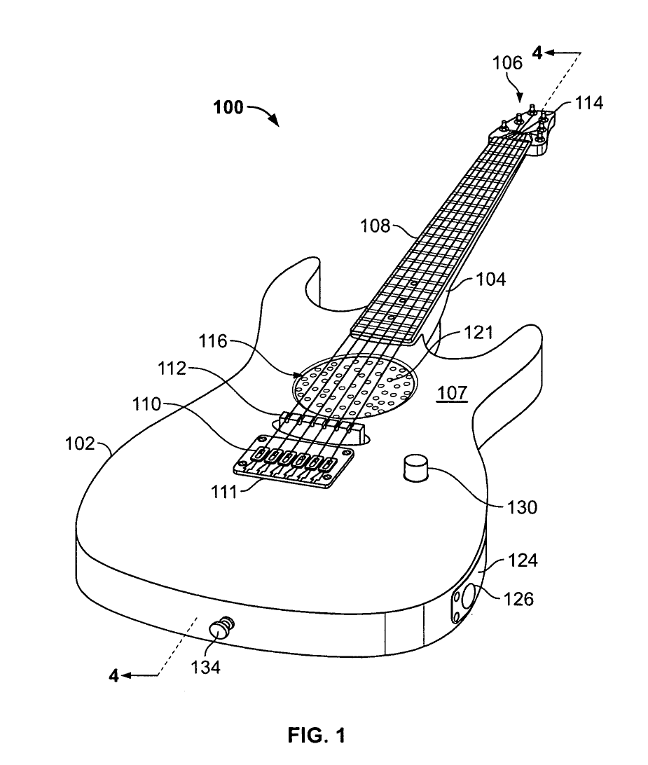

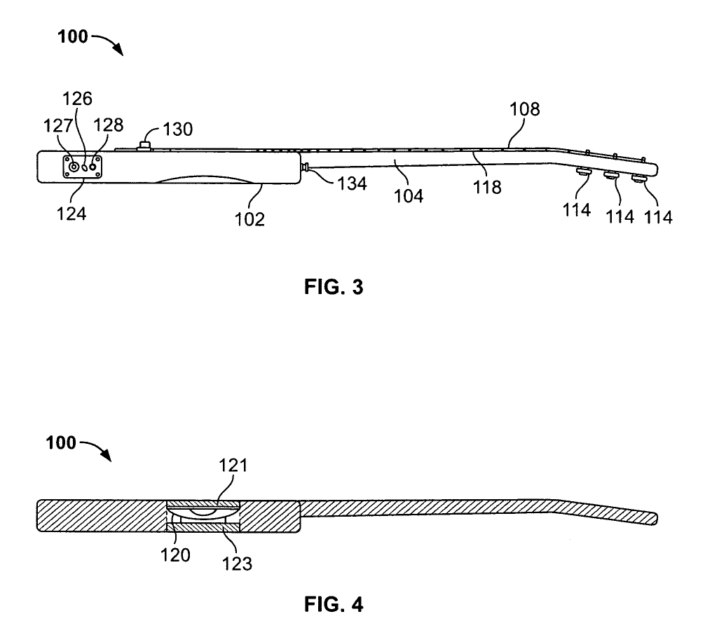

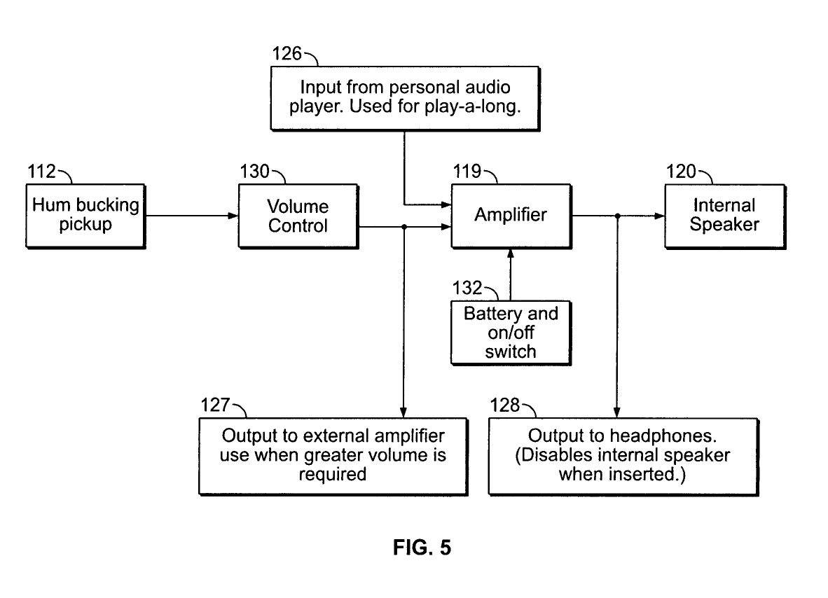

Referring to FIGS. 1-5, an embodiment of the present invention is illustrated where the electric guitar 100 includes a body 102, a neck 104 connected to the body and a head 106 connected to the neck. In the illustrated embodiment, the body 104 has a generally curved shape, and defines an interior space or hollow space. The body is made of a durable material such as wood. It should be appreciated that the body may be made from any suitable material or combination of materials. The body 102 includes electrical controls for controlling the sound and volume of the music played from the guitar 100 which are described in more detail below. It should be appreciated that the body 102 may have any suitable size or shape. The top surface 107 of the body is the support surface for the different parts of the guitar.

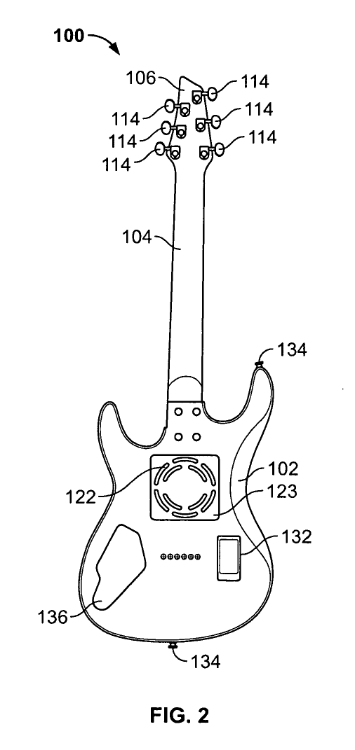

The neck 104 includes two ends where one of the ends is connected to the body 102 using suitable fasteners such as screws as shown in FIG. 2. The opposing end of the neck 104 includes the head 106 which is integrally formed with the neck. In another embodiment, the head 106 is a separate part which is connected to the neck 104. In the illustrated embodiment, the neck 104 has a relatively narrow tapered width that enables a guitar player to fit his/her hand substantially around the perimeter of the neck. It should be appreciated that the body 102, the neck 104, and the head 106 may have any suitable size or shape.

As illustrated in FIG. 1, the neck 104 includes a top surface known as the fingerboard that has a plurality of segregated sections or frets 118. The frets are metal pieces that are cut into the fingerboard at specific intervals. By pressing a string down onto a fret, you change the length of the string and therefore the tone it produces when it vibrates. The frets are spaced out so that the proper frequencies are produced when the string is held down at each fret. The frequencies determine the notes that are played by the guitar.

The guitar 100 includes a plurality of strings 108 which are stretched from the body 102 to the head 106. Specifically, one end of each of the strings 108 is connected to one of a plurality of string connectors 111 attached to an adjustable bridge 110. The bridge 110 is connected to the surface of the body 102 of the guitar as shown in FIG. 1 and secures the ends of the strings to the body.

A magnetic pick-up 112 is connected to the surface of the body 102 of the guitar and is intermediate to the adjustable bridge and the neck 104. The pick-up detects the movement or vibrations of the strings and converts the vibrations to electrical signals (i.e., analog signals) that ultimately become the sounds or music played by the guitar. The guitar may have one pick-up or a plurality of pick-ups that are each associated with one or more of the strings 108.

An opening or hole 116 is defined by the body of the guitar and extends through the body of the guitar (from the front surface to the bottom surface of the guitar). The hole 116 has a generally circular shape. It should be appreciated that the hole 116 may be any suitable size or shape. The strings 108 are stretched from the bridge 110 across the pick-up 112, the opening 116 and the frets 118 to the head 106. The ends of the strings 108 that are positioned on the head 106 are individually or independently connected to tuning pegs or tuners 114. Each tuner 114 is rotatably connected to the head 106. The guitar player rotates the tuners 114 to adjust the tension on the corresponding spring attached to that tuner. Adjusting the tension of the strings causes the strings to produce a different tone or sound. Adjusting or rotating each tuner 114 adjusts the tension on the string attached to the tuner to achieve a particular sound from that string as desired by the player.

The guitar 100 includes an amplifier 119 that is positioned in the interior space of the guitar. The amplifier receives the analog electrical signals from the pick-up 112 and amplifies the analog signals. The amplified analog signals are sent or transmitted to a built-in speaker 120 which converts the signals into a sound or sounds that are emitted from the guitar.

The speaker 120 is mounted in the opening 116 so that the body of the guitar acts as a baffle preventing the sound from the front of the speaker from canceling out the sound from the back or opposite side of the speaker. The speaker 120 includes a first cover 121, which is made from a piece of perforated metal having a plurality of openings, and a second cover 123, which is made from plastic and has a plurality of segmented curved channels 122. The sound from the speaker 120 is emitted from both covers 121 and 123. It should be appreciated that the perforations or openings in the first cover 121 and the channels in the second cover 123 may have any suitable size or shape. It should also be appreciated that the first and second covers 121 and 123 may be made of any suitable material or combination of materials. It should further be appreciated that the guitar 100 may include one or more speakers.

The built-in speaker 120 enables a guitar player to play their guitar and hear the sounds or music produced by the guitar directly from the speaker 120. The built-in amplifier and speaker 120 eliminates the need for a separate amplifier and/or speaker and thereby reduces the amount of equipment needed to play the guitar.

The guitar 100 also includes a connector plate 124 that is connected to the body 102 of the guitar. The connector plate 124 includes an input jack or input 126, a first output jack or first output 127, and a second output jack or second output 128.

The first output 127 is a conventional output, such as the output for an electric guitar, and is adapted to receive an electrical cord or cable which has two ends, one of which plugs into the first output 127 and the other which connects into an audio output device such as a separate external amplifier and speaker. The cable feeds the output from the instrument or guitar to the external amplifier and speaker for higher volume. The first output 127 may also be used to connect the electric guitar 100 to other output devices such as a stereo system, mixing system and the like.

The input 126 is adapted to receive a cable or cord connected from the electrical guitar to a separate music player, such as a digital music player or MP3 player, and not a cassette player. MP3 players, ipods, and similar digital music devices store numerous sound recordings or songs within a relatively small portable device. Some digital music players store thousands of songs. The input 126 enables the digital music players to be connected to the guitar and have the music stored in the memory of the digital music players to be played from the speaker 120 of the guitar. This enables a guitar player to play live music from the guitar 100 along with the songs played by the digital music player. Because most digital music players are relatively small and easily portable, a guitar player can virtually play live guitar music along with music played by their digital music player anywhere using the guitar 100. The digital players also enable the player to store and bring thousands of songs with them to different locations.

The second output 128 is adapted to receive a headphone connector or similar listening device. In areas or locations where the sound of the music must be kept to a minimum, or where the player wants to conceal the sound of their music, the headphones or listening devices enable the player to be the only one to listen to their music while they are playing. Additionally, output 128 can be used to connect or couple the guitar 100 to an external amplifier and speaker to play the combined sounds from the digital music player and the guitar 100 from the external amplifier and speaker. Output 128 can also be connected or coupled to an external recorder to record the combined sounds from the digital music player and the guitar for later study or enjoyment. It should be appreciated that any suitable listening devices, such as headphones, ear pieces, or other similar devices, may be connected to the output jack 128.

In an embodiment, the electric guitar 100 includes a volume/on/off adjustment knob 130. The knob 130 is rotatably connected to the body 102 of the guitar and enables a player to adjust the volume level of the sound coming from the speaker 120 and also to turn the guitar on or off.

In another embodiment, the guitar 100 can be played without the use of the digital player. In this embodiment, the guitar includes two or more volume control knobs (not shown) and enables the player to control the mix of the music by adjusting one or more of the knobs. It should be appreciated that the guitar may include one or more knobs to control different sound characteristics of the guitar.

In an embodiment, the guitar includes a battery housing 132 which stores one or more batteries to provide portable power to the guitar. The batteries enable the guitar 100 to be used in locations where electrical outlets or electrical power sources are non-existent. It should be appreciated that any suitable battery or batteries may be used to power the guitar.

The guitar 100 also includes two strap connectors 134. One of the strap connectors 134 is connected to an end of the body 102 and the other strap connector 134 is positioned on an opposing side of the guitar. The opposing strap connectors 134 enable the guitar player to connect a flexible strap such as a shoulder strap to the connectors so that the guitar can be positioned around a guitar player's body to make carrying and playing the guitar player less burdensome.

The guitar 100 also includes a wire plate 136 which conceals all the wiring inside the guitar. The wire plate 136 is removable to enable one or more of the wires to be repaired and/or replaced.

In use, a guitar player picks up the guitar 100 and connects an MP3 player, iPod or other digital player, to the input 126 on the guitar using a suitable connector such as a cord. The player then can put the digital player in their pocket, attach it to their pants, or carry the digital player in any manner that is comfortable for them. The player then turns the digital player on and plays a song that is recorded or stored in the memory of the digital music player. The music or song is then sent or transmitted to the guitar via the cord and played from the built-in speaker 120 on the guitar. The player plays the guitar by strumming or moving the strings 108. The vibrations or movements of the strings 108 are detected by the pick-up 112. The pick-up 112 converts the vibrations to analog electrical signals which are transmitted to the amplifier. The amplifier amplifies the analog signals from pick-up 112 and the analog signal from the digital music player (i.e., MP3 player or iPod) and applies that summed analog electrical signal to the speaker 120, which converts the summed analog electrical signal to sound. Thus, both the music from the digital player and the sounds from the instrument are simultaneously emitted from the speaker 120. The guitar player can adjust the volume of the instrument and/or the digital player to achieve the proper volume and sound mix from the speaker.

The guitar player has the ability to play along with numerous different songs using the guitar 100. Also because digital music players are small and portable, the player can play the guitar anywhere. The guitar player also does not have to deal with bulky equipment and spend significant time trying to set-up the equipment and adjust the volume and sound using the different pieces of equipment positioned around them.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A stringed instrument comprising:
a housing defining an interior space;
at least one string on said housing;
an amplifier positioned in said interior space and attached to said housing;
a pick-up on said housing and positioned adjacent to said string and being constructed and arranged to convert vibrations from said string into electrical signals and transmit said electrical signals to said amplifier;
an audio input on said housing and coupled to said amplifier, said audio input being constructed and arranged to be coupled to a digital music player, whereby sound stored by the digital music player is coupled to said amplifier; and
at least one speaker mounted in said housing and coupled to said amplifier;
wherein said amplifier converts electrical signals from said pick-up into live music and the speaker emits both the live music and the sound from the digital music player to enable a player to play along with the sound.

2. The stringed instrument of claim 1, which includes a plurality of pick-ups.

3. The stringed instrument of claim 1, wherein said speaker is a built-in speaker.

4. The stringed instrument of claim 1, which includes a plurality of speakers.

5. The stringed instrument of claim 1, which includes at least one additional audio output for a headphone.

6. The stringed instrument of claim 1, which includes at least one battery for providing electrical power to the instrument.

7. The stringed instrument of claim 1, which includes at least one controller on said housing and coupled to said amplifier for controlling volume.

8. The stringed instrument of claim 7, wherein said controller is constructed and arranged to further control at least one of: power on and power off.

9. The stringed instrument of claim 1, which includes an adjustable bridge movably connected to said housing and positioned adjacent to said string.
